(19) United States
(12) Patent Application Publication
(10) Pub. No.: US 2008/0043023 A1
(43) Pub. Date: Feb. 21, 2008

(54) APPROXIMATING SUBDIVISION SURFACES WITH BEZIER PATCHES

(75) Inventors: Charles T. Loop, Bellevue, WA (US); Scott David Schaefer, Bryan, TX (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/464,800

(22) Filed: Aug. 15, 2006

(51) Int. Cl. G06T 11/20

(52) U.S. Cl. 345/441

(57) ABSTRACT

Surface modeling systems and techniques are described which approximate Catmull-Clark subdivision surfaces. A quadrilateral mesh is analyzed by applying shape and tangent masks to faces on the quad-mesh. Through application of the shape masks, a shape patch is created which approximates the subdivision limit surface. This shape patch can be used for rendering surface shape. Through application of tangent masks, tangent patches are created which comprise tangent vectors which give rise to continuous normal vector fields, which can be used for shading of the surface.

### BACKGROUND

Subdivision surfaces, and Catmull-Clark subdivision surfaces in particular, have become a standard modeling primitive in computer generated motion pictures and 3D games. Subdivision surfaces facilitate modeling by utilizing a course polygonal control mesh which is constructed to approximate the shape of a desired surface. The mesh is then recursively refined to produce a set of finer meshes that converge to a smooth shape. One example of such a shape can be found in FIG. 1. FIG. 1 illustrates a seven-sided polygonal mesh 110 which represents the smooth egg-like shape. As the shape is progressively refined, faces are added to the polygonal mesh and the mesh converges to the spherical shape. Shapes 120, 130, and 140 show successive refinement steps according to a Catmull-Clark subdivision scheme. Other implementations of subdivision modeling exist, such as, for example, the Doo-Sabin, Loop, and Butterfly subdivision schemes. While techniques and processes are described herein with reference to Catmull-Clark subdivision surfaces, in other implementations these techniques may be modified to operate on subdivision surfaces according to these other schemes.

Use of subdivision modeling techniques allows complex surfaces to be represented in a Graphics Processing Unit (“GPU”) in a compact way before determining shape and lighting parameters necessary for rendering the shape graphically. Thus, the smooth surface which is progressively approximated in FIG. 1 can be represented by the simple polygonal mesh 110, which requires a relatively small amount of data to be stored and transmitted, reducing GPU bandwidth. Another example can be found in FIG. 2, where a complex shape 220 is represented by the relatively sparse polygonal mesh 210.

In practice, according to existing techniques, three or four refinement steps are typically necessary to produce a mesh which is sufficiently dense to be suitable for rendering. For real-time applications, however, these successively refinements produce meshes with a great many polygons, requiring complicated and resource intensive level-of-detail schemes to avoid overwhelming graphics pipelines with triangles. Oftentimes a balance must be struck between fidelity and static triangle count, resulting in shapes that take on a faceted appearance.

Some existing techniques have used GPUs to dynamically tessellate Catmull-Clark surfaces. While utilizing hardware to speed up modeling, the performance of these schemes is not impressive. Additionally, as GPUs continue to evolve, support for higher order tessellation will become a reality. In these techniques, a unit square domain is tessellated based on user specified weights associated with edges or vertices. A user supplied program is then called with the parametric (e.g., (u, v)) positions of tessellation vertices. These techniques provide advantages of flexibility, the details of patch evaluation being controlled by software, and parallelism because multiple arithmetic units can be running the same evaluation program at the same time.

Catmull-Clark subdivision surfaces in particularly are piecewise parametric; however this representation typically requires an infinite number of bicubic patches. Stam developed one technique for efficiently evaluating the parametric form of Catmull-Clark surfaces. However, while programmable tessellation hardware will be capable of implementing this technique, there are a number of issues that result in sub-optimal performance. Stam's technique requires extraordinary vertices (i.e. those vertices which receive more than four edges in the polygonal control mesh) to be isolated by running an extra subdivision step on the mesh.

In practice, this means that four times as many patches are needed than the number of faces in the control mesh (for an example control mesh comprising all quadrilaterals). These patches have a variable number of control points that must be projected into an eigenspace before evaluation begins; this projection eliminates the possibility to share control points among adjacent patches. The evaluation itself requires that 32n+8 bicubic eigenbasis functions be evaluated (patch with valence n); the 32n+128 coefficients of these functions must be read from memory for each evaluation instance. This means the technique results in a large number of patches which cannot share patch data, and which require a large number of constants to be computed. This can tax hardware resources. What is needed is a method for modeling Catmull-Clark subdivision surfaces with sufficient detail while requiring fewer total computations.

### SUMMARY

Surface modeling systems and techniques are described which approximate Catmull-Clark subdivision surfaces. In various implementations, quadrilateral meshes are analyzed by applying shape and tangent masks to faces on the meshes. Through application of the shape masks, a shape patch is created which approximates a portion of the subdivision limit surface. This shape patch can then be used for rendering surface shape. In one implementation, because shape patches do not provide continuous normal vector fields, tangent vectors are developed through application of tangent masks. Thus, tangent patches are created which comprise tangent vectors which give rise to continuous normal vector fields. These fields can then be used for shading of the surface.

In one example implementation, a method of modeling a surface is described, the surface being represented as a mesh of quadrilaterals. The method comprises, for each of one or more of the quadrilaterals, generating one or more control points for a Bézier patch which approximates a subdivision limit patch for the quadrilateral by applying one or more masks to the quadrilateral.

In another example implementation, a computer-implemented system for displaying a surface is described. The system comprises a shape-approximation module configured to approximate shapes for one or more faces of a quadrilateral mesh approximating a Catmull-Clark subdivision surface by applying one or more shape masks to each of the one or more faces. The system also comprises a tangent-approximation module configured to approximate tangent vectors for one or more faces of the quadrilateral mesh by applying one or more tangent masks to each of the one or more faces. The system also comprises a display module configured to render the approximated surface for a display at least in part based on the approximated shapes and the approximated normal vectors.

In another example implementation, computer-readable media are described. The computer-readable media contain instructions which, when executed by a computer cause the computer to perform a method for displaying a Catmull-Clark limit surface. The method comprises performing Catmull-Clark subdivision on a subdivision surface to create a quadrilateral mesh representing the surface, for each face of the quadrilateral mesh, applying shape masks to the face in order to create a shape patch which approximates a Catmull-Clark limit surface for the face, and displaying one or more of the approximated patches in order to display the surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be made apparent from the following detailed description of embodiments that proceeds with reference to the accompanying drawings.

### BRIEF DESCRIPTION OF THE DRAWINGS

FIG. 1 illustrates examples of subdivision surfaces.

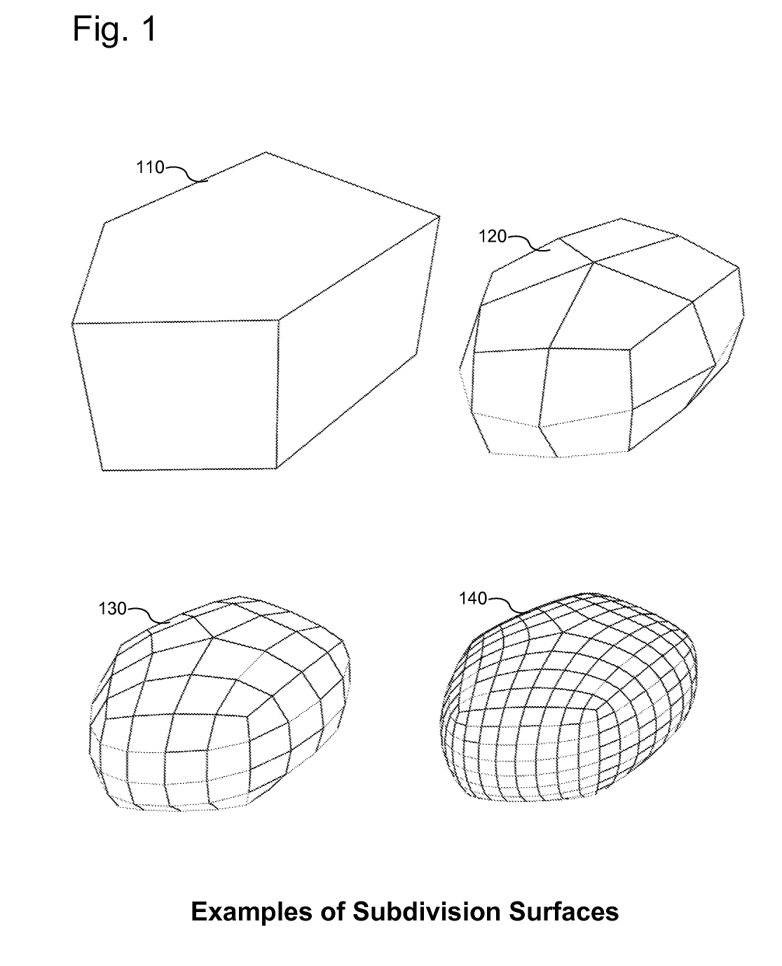

FIG. 2 also illustrates examples of subdivision surfaces.

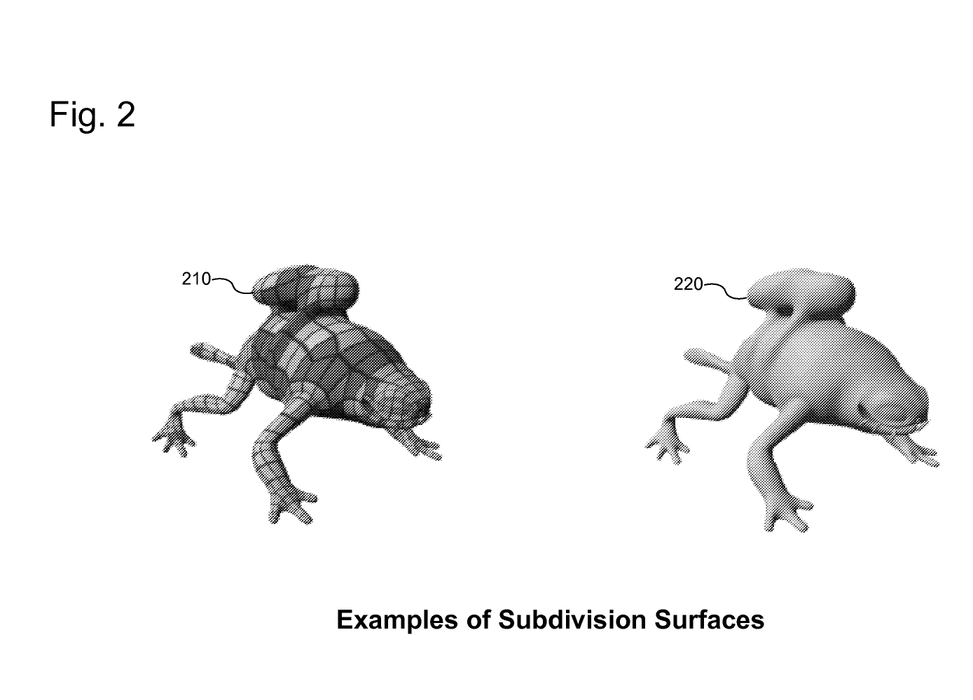

FIG. 3 is a block diagram illustrating an example system for displaying Catmull-Clark subdivision surfaces.

FIG. 4 is a flowchart illustrating an example process performed by the system of FIG. 3 for displaying a Catmull-Clark subdivision surface.

FIG. 5 is a diagram illustrating examples of labeling of control points created by the process of FIG. 4 which approximate a Catmull-Clark surface shape.

FIG. 6 is a diagram illustrating examples of masks used to create Bézier patches from B-spline surface points in a quadrilateral mesh.

FIG. 7 is a diagram illustrating examples of shape masks used in the process of FIG. 4 for approximating Catmull-Clark surface shape.

FIG. 8 is a flowchart illustrating an example process performed as part of the process of FIG. 4 for approximating a Catmull-Clark surface shape.

FIG. 9 is a diagram illustrating examples of tangent vector patches control points created by the process of FIG. 4 which approximate tangent vectors for a Catmull-Clark surface.

FIG. 10 is a diagram illustrating an example of a tangent mask used in the process of FIG. 4 for approximating tangent patches for a Catmull-Clark surface.

FIG. 11 is a flowchart illustrating an example process performed as part of the process of FIG. 4 for approximating tangent patches for a Catmull-Clark surface shape.

FIG. 12 is a diagram illustrating an example of labeling of vectors used in generating a tangent patch.

FIG. 13 is a block diagram illustrating an example computing environment for performing the surface approximation techniques described herein.

### DETAILED DESCRIPTION

The exemplary techniques and systems described herein approximate Catmull-Clark subdivision surfaces with a collection of bicubic patches. Construction of the collection allows a relatively small number of patches to be used, lessening the data transfer and computational requirements of the technique. Because the patches created by this technique are only piecewise continuous but not smooth, shading discontinuities can result from straightforward application of shaders to the patch shapes. The techniques and systems describe herein address this quality by creating independent tangent vector patches that are used together to produce a continuous normal field. In one implementation, the collection of patches is referred to as minimal, since a single rectangular patch is created for each face of a quadrilateral mesh (“quad-mesh”).

1. Examples of Surface Modeling and Display Systems

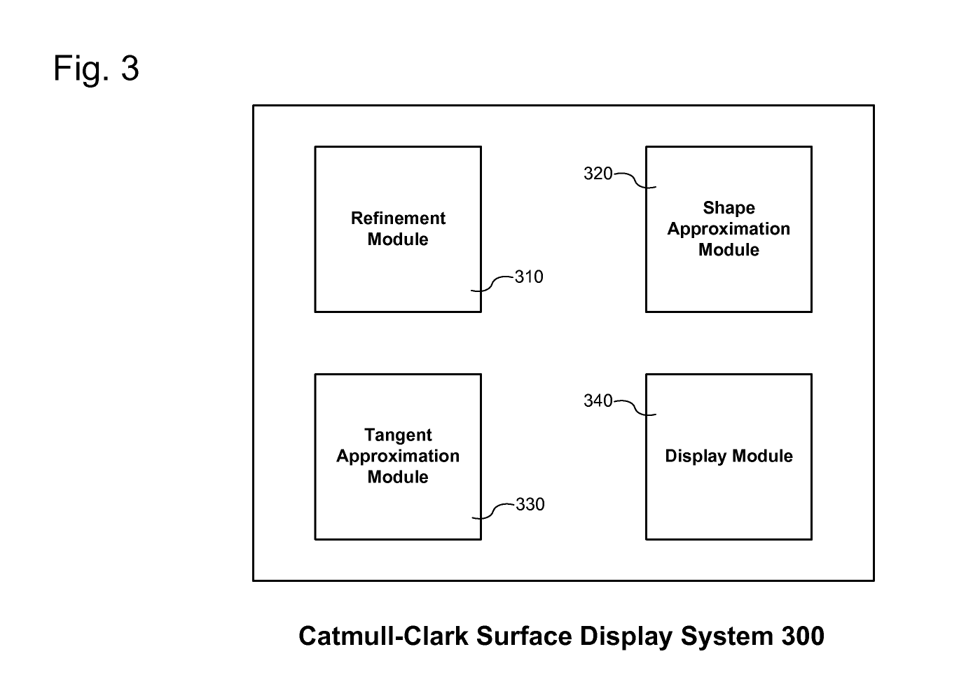

FIG. 3 is a block diagram illustrating a Catmull-Clark Surface Display System 300 which utilizes the surface approximation techniques to model surfaces from input control meshes. FIG. 3 illustrates modules 310-340 which perform various processes in the course of performing the surface approximation techniques described herein. While the modules of FIG. 3 are illustrated separately, in various implementations the modules may be combined or split into more modules; additionally, the modules may represent hardware, software, or a combination thereof In particular implementations, one or more modules or procedures of the display system 300 may be performed by a GPU.

In the illustrated implementation, the display system 300 comprises a subdivision module 310. In one implementation, this subdivision module refines a control mesh to an acceptable level before the subdivision shape is approximated. For example, in one implementation, the subdivision module performs a single Catmull-Clark refinement before approximation is performed. This is done because, in one implementation, the approximation techniques described herein are performed on quad-meshes. Thus, a Catmull-Clark refinement of a control mesh, which always produces a quad-mesh regardless of the shapes in the original control mesh, provides a quad-mesh for the approximation. In alternative implementations, the refinement module may perform other techniques to ensure a quad-mesh is provided for approximation procedures, or may not operate at all, for example if the original control mesh comprises only quadrilaterals.

The illustrated implementation also shows that the display system 300 comprises shape approximation modules 320 and tangent approximation module 330. In one implementation, these modules operate on the quad-mesh produced by the refinement module 310 to produce shape and tangent vector approximations, respectively, for faces on the quad-mesh. In one implementation, a select subset of all faces of the quad mesh are approximated, for example, only those which are visible according to the orientation of the object being modeled. In an alternative implementation, shapes which are not visible according to the object's orientation are also approximated.

Finally, the illustrated implementation shows that the display system 300 comprises a display module. In one implementation, this module serves to take the shape and tangent vector approximations and render the shape being approximated for viewing. This is done, for example, by using the shape approximations to render the shape of the object while using the tangent vector approximations to generate normal vectors, which are then used for shading during the rendering process. In another implementation, the tangent approximation module may be configured to produce normal vectors for each approximated face of the control mesh; in this implementation, the display module can perform shading based on the approximated normal vectors.

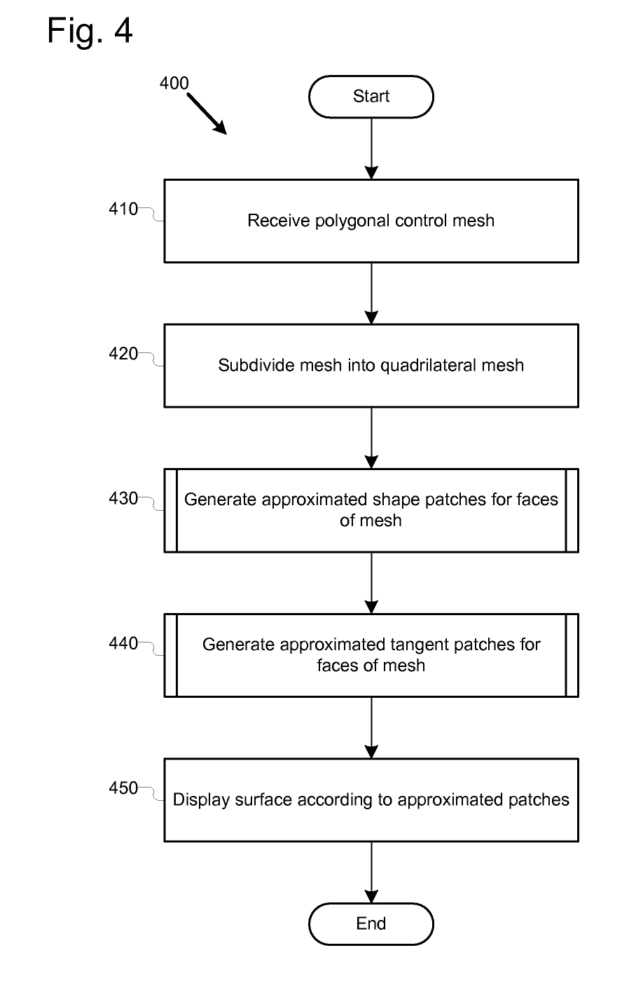

FIG. 4 is a flowchart of an example process 400 performed by the display system 300 for displaying a shape described by a control mesh according to the techniques described herein. In various implementations, the illustrated process blocks may be merged, divided into sub-blocks, or omitted. The process begins at block 410, where a polygonal control mesh is received for display. In one implementation, this polygonal control mesh is constructed so that, when refined repeatedly by Catmull-Clark subdivision, each progressively refined polygon will converge to a desired surface. In the context of this application, this shape will be referred to as the Catmull-Clark limit surface. Next, at block 420, the mesh is refined into a quadrilateral mesh. In one implementation, this is done by the refinement module 310 performing a single Catmull-Clark subdivision process on the received control mesh. In other implementations, other processes for creating a quad-mesh can be utilized.

Next, at block 430, the shape approximation module 320 generates approximated shape patches for faces of the refined control mesh. Next, at block 440, approximated tangent patches are generated by the tangent approximation module 330 to provide tangent vector data for shading. As mentioned above, in various implementations, different sets of faces may be approximated in the processes of either of these blocks. Particular exemplary implementations of these blocks are described below. Finally, at block 450, the approximated patches are used by the display module 340 to display the surface.

2. Examples of Shape Patch Approximation

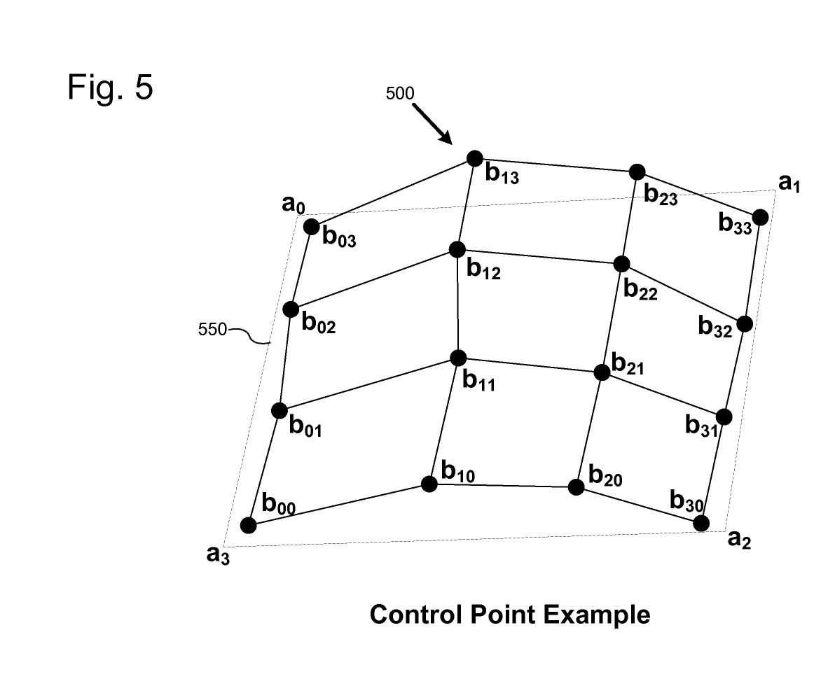

The techniques described herein approximate shape for faces of a control mesh by constructing a bicubic patch corresponding to each approximated face of the quad-mesh. These patches are in Bézier form. FIG. 5 gives an example of Bézier control points 500 for a shape patch which approximates a control mesh face 550. The labeling scheme used in FIG. 5 will be used herein in order to facilitate clear description. This labeling technique is not intended to illustrate any particular limitation on data or data representation in the procedures described herein; alternative implementations may use different labeling techniques.

The procedures described herein may be better understood in the context of B-spline knot insertion, which is used to convert curves or (in the illusrated examples, surfaces) from a B-spline basis to a Bézier basis. If all four vertices of a quad-mesh face have valance 4, then the construction reproduces a standard uniform B-spline patch, in Bézier form.

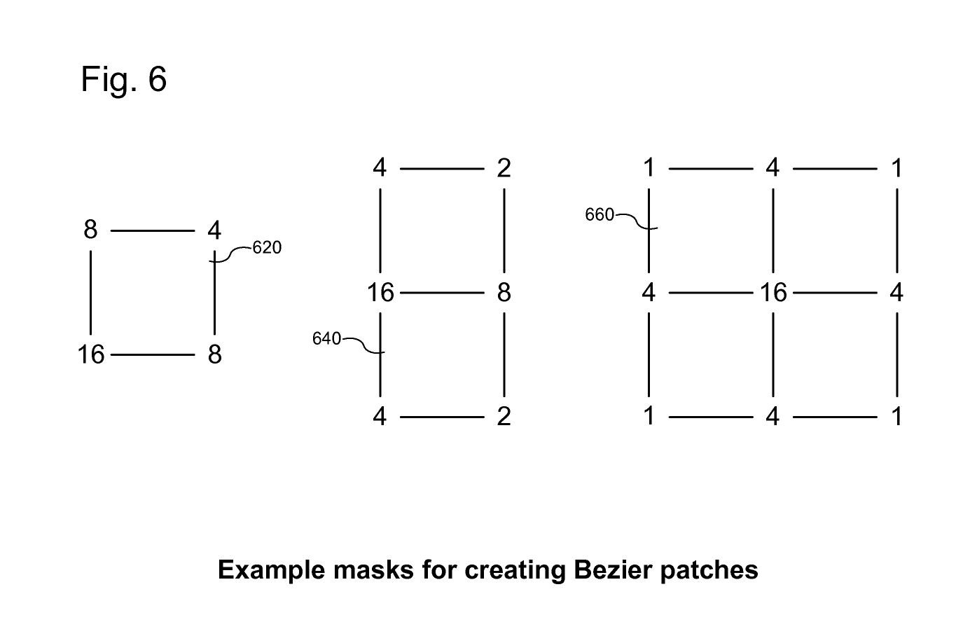

According to one technique, there are three types of masks needed to construct the control points of Bézier patches from a uniform B-spline control mesh; these masks are shown as masks 620, 640, and 660 of FIG. 6. As used herein, a “mask” is a set of weights used in a geometric construction. The layout of the mask diagram suggests the relationship of the weights of the mask to a configuration of points to which it is applied. For masks that generate points, the mask weights are normalized to sum to 1. This normalization is generally implied, as it is in the illustrated masks of FIG. 6, which have an implied normalizing scale factor of 1/36. Masks that generate vectors, however, sum to 0 and thus do not have an implied normalization.

Mask application is the sum of products of weights and points. Thus, mask 620 of FIG. 6 is used (in four orientations) to create the four interior control points b₁₁, b₁₂, b₂₂, and b₂₁, as seen in FIG. 5. Thus, in the example of FIG. 5, control point b₁₂ is created as a linear combination:

$${b}_{12} = \frac{16 {a}_{0} + 8 {a}_{1} + 8 {a}_{3} + 4 {a}_{2}}{36}$$

By then rotating the mask three more times and applying it to the edges of the quad face each time, the other points b₁₁, b₂₂, and b₂₁ can also be obtained. Each of these points corresponding to the quadrilateral face for which the approximation patch is created.

Mask 640 of FIG. 6 is used (in different orientations) to create a patch boundary points b₁₀, b₂₀, b₀₁, b₀₂, b₁₃, b₂₃, b₃₂, and b₃₁ corresponding to the edges the quad-mesh. In this application, the mask is applied not only to points in the particular quad face illustrated in FIG. 5, but also to points contained in adjacent quad faces. Finally, mask 660 is used to create patch corner points b₀₀, b₀₃, b₃₃, and b₃₀, which correspond to the vertices of the quad-mesh. Using this technique, a geometric relationship exists between the Bézier points is apparent. In the situation where each vertex has valence of 4, each boundary point lies at the midpoint of two interior points, belonging to adjacent faces and each corner point lies at the centroid of four interior points that surround a vertex.

The techniques described herein utilize shape masks which operate similarly to the constrained masks above, but which are able to operate on quad faces with extraordinary vertices. Thus, the techniques described herein can operate on polygonal quad control meshes which have vertices receiving a number of edges other than four.

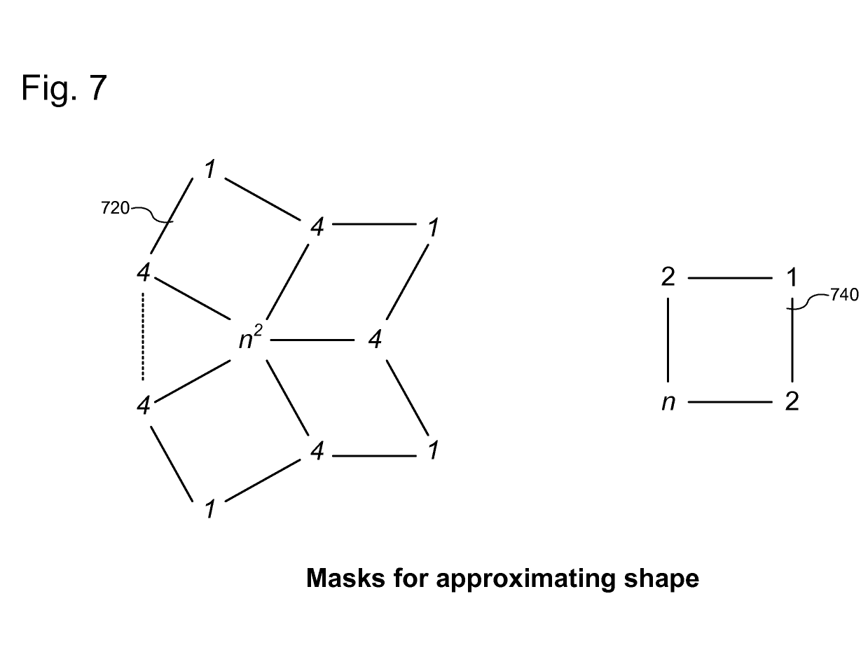

The shape masks described below are constructed such that the corner points b₀₀, b₀₃, b₃₃, and b₃₀ interpolate the limit position of the Catmull-Clark surface at the corresponding vertices. It has been shown that left eigenvectors corresponding to the dominant eigenvalue of a Catmull-Clark subdivision matrix can be a mask for determining the limit position of the corresponding extraordinary vertex. One implementation of such a mask is illustrated in FIG. 7 as shape mask 720. A second shape mask, 740, is the mask used by the processes described herein to obtain control points for a shape patch which approximates a Catmull-Clark surface. As described below, application of shape mask 740 to quad faces, along with generation of additional control points results in the approximation of the control point at an extraordinary vertex which results from application of mask shape 720.

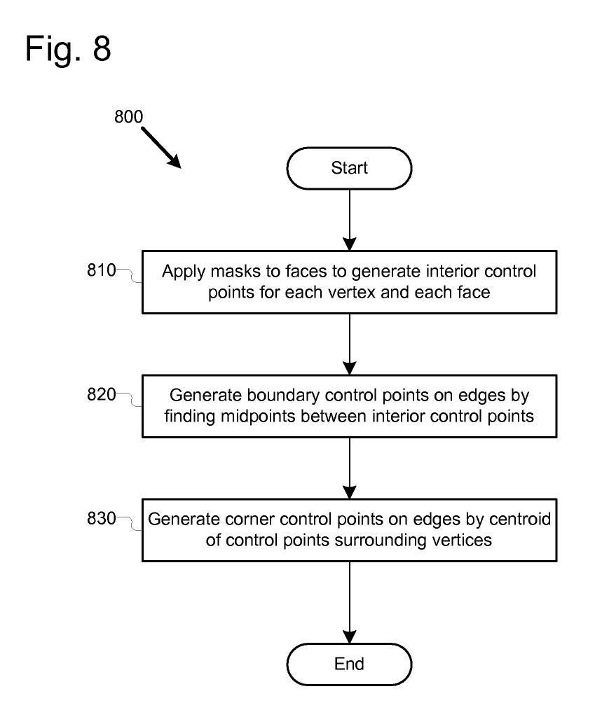

FIG. 8 is a flowchart of an example process 800 performed by the shape approximation module 320 for generating Bézier control points which describe a shape patch which approximates Catmull-Clark limit surfaces for a given quad face. In various implementations, the illustrated process blocks may be merged, divided into sub-blocks, or omitted; in various implementations the various sub-processes may be performed in an order different than that illustrated. While the blocks of process 800 may appear to describe the generation of all of all interior control points, followed by collections of other types of control points, it should be noted that this is done melrely for the sake of clarity. In various implementations, the processes of FIG. 8 may be applied in various orders, or may be applied to particular quad faces before they are applied to other quad faces.

The process begins at block 810, which utilizes interior control point mask 740 of FIG. 7 to create generalized interior points b₁₁, b₁₂, b₂₂, and b₂₁, with the property that the Catmull-Clark limit position will lie at the centroid of the n interior points that surround an extraordinary vertex. In the process of block 810, the mask is applied (in four different orientations) in the same way as the application of the mask 620 described above. Note that the value n in the interior point mask corresponds to the valance n of the vertex getting the weight n; because of this, the value n may differ for each interior point of a given face. However, as each interior point corresponds to a vertex-face pair, each interior point corresponding to the same vertex will have the same value for n.

Next, at block 820, boundary points b₀₀, b₂₀, b₀₁, b₀₂, b₁₃, b₂₃, b₃₂, and b₃₁ corresponding to quad-mesh edges are found as the midpoints of interior points corresponding to the incident faces of the edge each boundary point is found on. Finally, at block 830, the patch corner points b₀₀, b₀₃, b₃₃, and b₃₀ are found as the centroid of interior points surrounding their corresponding mesh vertex that. By construction, these patch corner points are the respectively limit positions under Catmull-Clark subdivision. It can also be appreciated that the centroid of the interior control points generated using the shape mask 740 will correspond to a point generated by the generalized shape mask 720.

3. Examples of Tangent Patch Approximation

Because the shape patches generated by the above process are not smoothly continuous, the techniques described herein utilize a separate tangent vector patch generation procedure in order to develop tangent vectors from which surface normal vectors may be obtained for shading purposes and displacement mapping. In this process, a pair of patches are constructed that approximate the partial derivative (∂u and ∂v) tangent fields of the patches constructed in the previous section. The surfaces represented by these tangents are adjusted so that the limit normal of the underlying Catmull-Clark surface is interpolated at each extraordinary vertex. The tangent patches thus lead to a continuous normal field on patch boundaries.

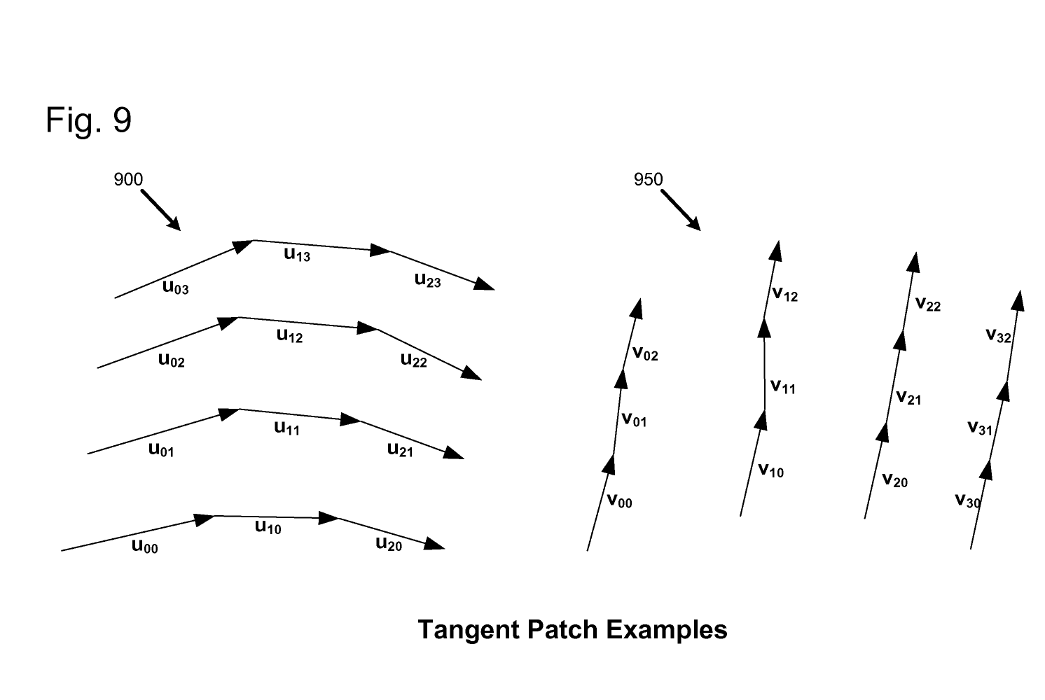

FIG. 9 illustrates an example tangent patch 900 which represents ∂u. The patch is bidegree 2×3, since, if this were a real tangent patch created from differentiating an approximated shape patch, differentiation with respect to u would lower the degree by one in that direction. Similarly, example tangent patch 950, which represents ∂v, is bidegree 3×2. Since tangent patches 900 and 950 represent vector fields, their coefficients are control vectors, as illustrated in FIG. 9. The construction of tangent patches is similarly performed for each of the parameters u and v; that is, in one implementation the constructions are identical up to an interchange of principle directions, with appropriate change of signs. For this reason, and for the sake of clarity, the proceeding description will only show the construction for ∂u.

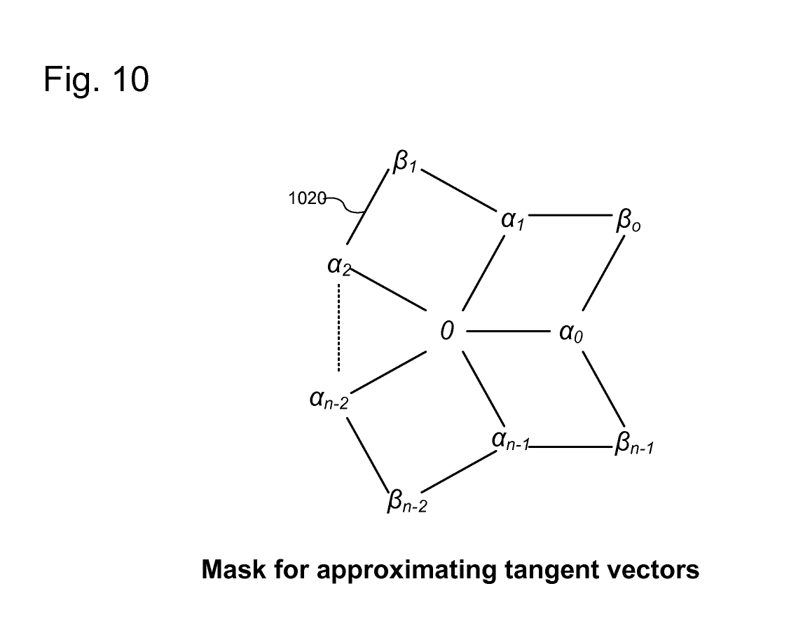

Similarly to the processes described above, a first step in generating the tangent patches is to determine corner vectors u₀₀, u₂₀, u₀₃,and u₂₃ that agree with the limit tangent of the Catmull-Clark surface. Furthermore, these vectors are chosen to coincide with parameter directions emanating from each extraordinary vertex and are constructed to be scaled in a reasonable way. The techniques described herein utilize a mask to determining tangent vectors; for the purposes of clarity the labeling scheme of the tangent mask 1020 depicted in FIG. 10 will be used herein to describe the weights used in such a vector generating mask for a vertex of valence n.

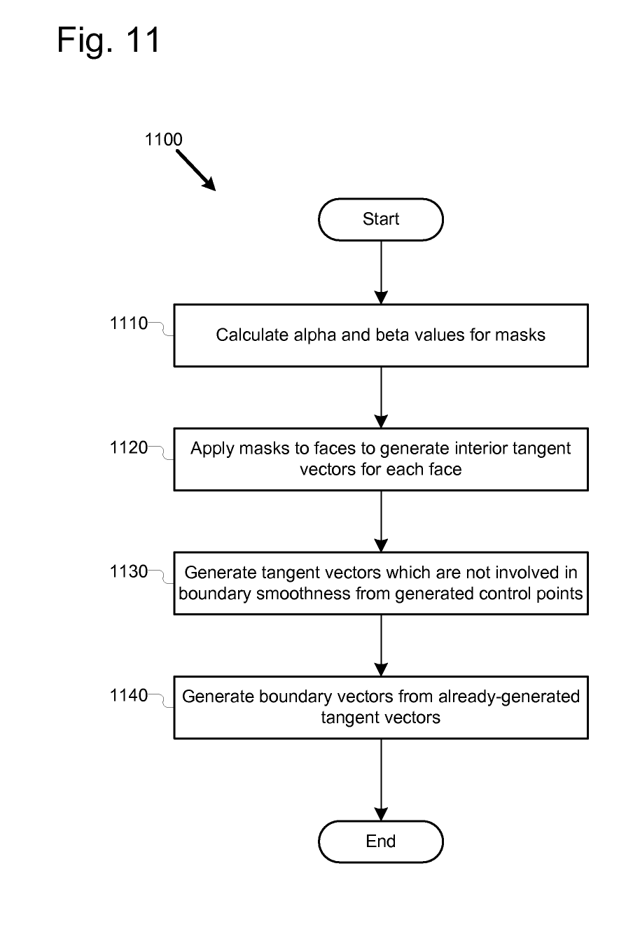

FIG. 11 is a flowchart of an example process 1100 performed by the tangent approximation module 330 for generating tangent patches which approximates tangents for Catmull-Clark limit surfaces for a given quad face. In various implementations, the illustrated process blocks may be merged, divided into sub-blocks, or omitted; in various implementations the various sub-processes may be performed in an order different than that illustrated. While the blocks of process 1100 may appear to describe the generation of all of all interior control points, followed by collections of other types of control points, it should be noted that this is done melrely for the sake of clarity. In various implementations, the processes of FIG. 11 may be applied in various orders, or may be applied to particular quad faces before they are applied to other quad faces.

The process begins at block 1100 where α and β values are chosen for the tangent mask 1020 according to the labeling of FIG. 10. It is known that the pair of left eigenvectors corresponding to the subdominant eigenvalue pair of a Catmull-Clark subdivision matrix are masks for a pair of vectors that span the limit tangent at an extraordinary point. Since mask application is linear, any linear combination of limit tangent masks will also be a left eigenvector and a mask for generating a vector in that limit tangent plane. Consider the unique symmetric linear combination, using the labeling of FIG. 10, where the left eigenvector lα₀=1. Thus:

$$l {α}_{i} = cos \frac{2 π i}{n} , \\ l {β}_{i} = ( \frac{\sqrt{4 + {( cos \frac{π}{n} )}^{2}} - cos \frac{π}{n}}{4} ) cos \frac{2 π i + π}{n} .$$

A mask generated according to these values will determine a vector in the tangent plane for the limit surface corresponding to the direction of the neighbor vertex with weight lα₀. However, in order to provide well-behaved surfaces (e.g. surfaces from which a continuous normal field can be found), an appropriate scale for this vector should be calculated.

The right eigenvectors corresponding to the pair of subdominant eigenvalues of a subdivision matrix are known to be associated with the characteristic map of the subdivision scheme. The control net for the characteristic map lies in the plane with vertex coordinates corresponding to the pair of right eigenvectors. Consider the 1-ring of the unique symmetric characteristic map whose first coordinate is given by

$$r {α}_{i} = cos \frac{2 π i}{n} , \\ r {β}_{i} = ( \frac{4}{\sqrt{4 + {( cos \frac{π}{n} )}^{2}} + cos \frac{π}{n}} ) cos \frac{2 π i + π}{n} .$$

If the limit tangent mask is applied to this net, the result will be a scalar (corresponding to the first coordinate of the limit tangent vector). Thus, it is useful to find a scale factor σ so that the limit tangent vector is has unit value. Symbolically, this means finding σ so that:

$$σ {\sum }_{i = 0}^{n - 1} l {α}_{i} r {α}_{i} + l {β}_{i} r {β}_{i} = 1.$$

Solving this linear equation gives:

$$σ = \frac{1}{n} + \frac{cos \frac{π}{n}}{n \sqrt{4 + {( cos \frac{π}{n} )}^{2}}}$$

The rationale behind this choice for σ is that so-called characteristic coordinates are a natural local frame for a subdivision surface at an extraordinary vertex. In this frame, the scale factor σ leads to a unit length tangent. Summarizing this result gives values for a limit tangent mask of:

$${α}_{i} = ( \frac{1}{n} + \frac{cos \frac{π}{n}}{n \sqrt{4 + {( cos \frac{π}{n} )}^{2}}} ) cos \frac{2 π i}{n} , \\ {β}_{i} = ( \frac{1}{n \sqrt{4 + {( cos \frac{π}{n} )}^{2}}} ) cos \frac{2 π i + π}{n} .$$

Thus, in block 1110, the above values are calculated and in block 1120 tangent masks using these values are applied to vertices to construct the vectors u₀₀, u₂₀, u₀₃,and u₂₃. In one implementation, these vectors are be consistently aligned. This means that tangent vector directions are reversed (e.g., multiplied by −1) for u₂₀, and u₂₃. Also, in the processes of blocks 1110 and 1120, the construction of tangent field corner vectors v₀₀, u₀₂, u₃₀,and u₃₂ is performed in a similar fashion, the details of which are not printed herein for the sake of clarity.

Next, at block, 1130, the internal tangent control vectors which are not involved in boundary smoothness are generated from control points which were previously determined by the shape approximation processes discussed above. In one implementation, these vectors are calculated by:

u_{1,j}=3(b_{2,j}−b_{1,j}), j=0, . . . , 3

### Also at block 1130 a similar calculation is performed for each v_{j,1}. In one implementation, these control vectors can be generated on-the-fly and need not be stored explicitly.

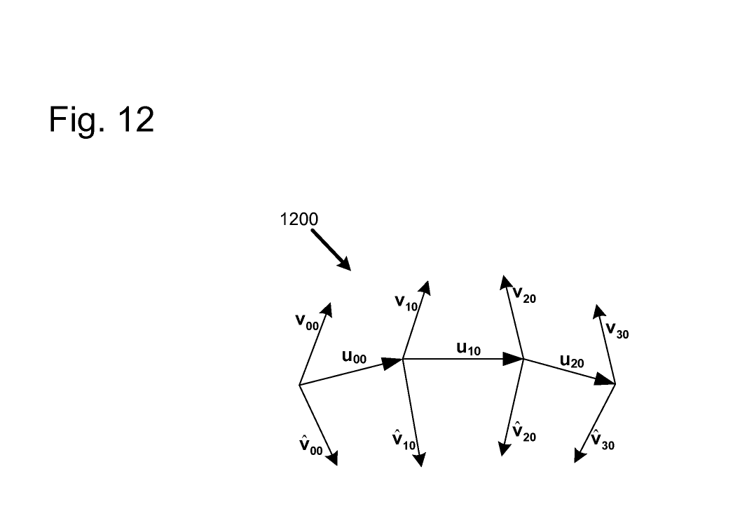

Finally, at block 1140 boundary tangent vectors are generated from the already-generated tangent vectors. Thus, once the corner and internal tangent control vectors for tangent field patches representing ∂u and ∂v have been constructed, the process can find vectors on patch edges that will lead to a continuous normal field. FIG. 12 illustrates one example labeling 1200 of control vectors along patch edges. Using the labeling 1200, one implementation of the process of block 1140 assumes that vectors u₀₀, u₁₀, u₂₀, v₀₀, v₃₀, \hat{v}₀₀, and \hat{v}₀₀ have been constructed as previously described. The process of block 1140 constructs vectors v₁₀,v₂₀, \hat{v}₁₀, and \hat{v}₂₀ that satisfy the smoothness conditions derived below.

For the patch boundary shown in FIG. 12, there are three illustrated tangent vector fields, which can be defined by:

u(t)=u₀₀(1−t)²+2u₁₀(1−t)t+u₂₀t²

v(t)=v₀₀(1−t)³+3v₁₀(1−t)²t+3v₂₀(1−t)t²+v₃₀t³,

\hat{v}(t)=\hat{v}₀₀(1−t)³+3\hat{v}₁₀(1−t)²t+3\hat{v}₂₀(1−t)t²+\hat{v}₃₀t³.

To obtain a continuous normal field, these tangents must be linearly dependent for each t ε[0,1]. By construction all the tangent vectors about the same extraordinary vertex will form an affine image of an n-gon; this follows from a property of the limit tangent mask. Therefore, at the endpoints t=0 and t=1, it follows that:

$${c}_{0} {u}_{00} = \frac{1}{2} ( {v}_{00} + {\hat{v}}_{00} ) , and - {c}_{1} {u}_{20} = \frac{1}{2} ( {v}_{30} + {\hat{v}}_{30} )$$

$$where {c}_{0} = cos \frac{2 π}{{n}_{0}} and {c}_{1} = cos \frac{2 π}{{n}_{1}} ,$$

with n₀ and n₁ being the valance of the first and second endpoints, respectively. Linear dependence of the vector fields then will result if

$$( {c}_{0} ( 1 - t ) + {c}_{1} t ) u ( t ) = \frac{1}{2} ( v ( t ) + \hat{v} ( t ) ) .$$

Solving for the polynomial coefficients of this expression in the Bernstein basis results in the four conditions:

$$\begin{matrix}{c}_{0} {u}_{00} = \frac{1}{2} ( {v}_{00} + {\hat{v}}_{00} ) , & ( 1 ) \\ \frac{1}{3} ( 2 {c}_{0} {u}_{10} - {c}_{1} {u}_{00} ) = \frac{1}{2} ( {v}_{10} + {\hat{v}}_{10} ) , & ( 2 ) \\ \frac{1}{3} ( {c}_{0} {u}_{20} - 2 {c}_{1} {u}_{10} ) = \frac{1}{2} ( {v}_{20} + {\hat{v}}_{20} ) , & ( 3 ) \\ {c}_{1} {u}_{20} = \frac{1}{2} ( {v}_{30} + {\hat{v}}_{30} ) . & ( 4 )\end{matrix}$$

Conditions (1) and (4) are satisfied by construction. Condition (2) can be satisfied by

$${v}_{10} = \frac{1}{3} ( 2 {c}_{0} {u}_{10} - {c}_{1} {u}_{00} ) + x , \\ {\hat{v}}_{10} = \frac{1}{3} ( 2 {c}_{0} {u}_{10} - {c}_{1} {u}_{00} ) + x ,$$

for any choice of x. Subtracting the second equation from the first gives that

$$x = \frac{1}{2} ( {v}_{10} - {\hat{v}}_{10} ) .$$

x can then be interpreted geometrically as a vector directed across the boundary toward the interior of the patch. One implementation chooses x=3(b₁₁-b₀₀) since, by construction, the same vector x (up to sign) is obtained when constructing both patches sharing an edge. To summarize, the process of block 1140 sets:

$${v}_{10} = \frac{1}{3} ( 2 {c}_{0} {u}_{10} - {c}_{1} {u}_{00} ) + 3 ( {b}_{11} - {b}_{10} ) , \\ {v}_{20} = \frac{1}{3} ( {c}_{0} {u}_{20} - 2 {c}_{1} {u}_{10} ) + 3 ( {b}_{21} - {b}_{20} ) .$$

The construction for \hat{v}₁₀ and \hat{v}₂₀ is similar. The control vectors u₀₁ and u₀₂ are constructed in this block similarly, as are v₁₂,v₂₂,u₂₁ and u₂₂. Some constructions will utilize a directional reversal.

4. Computing Environment

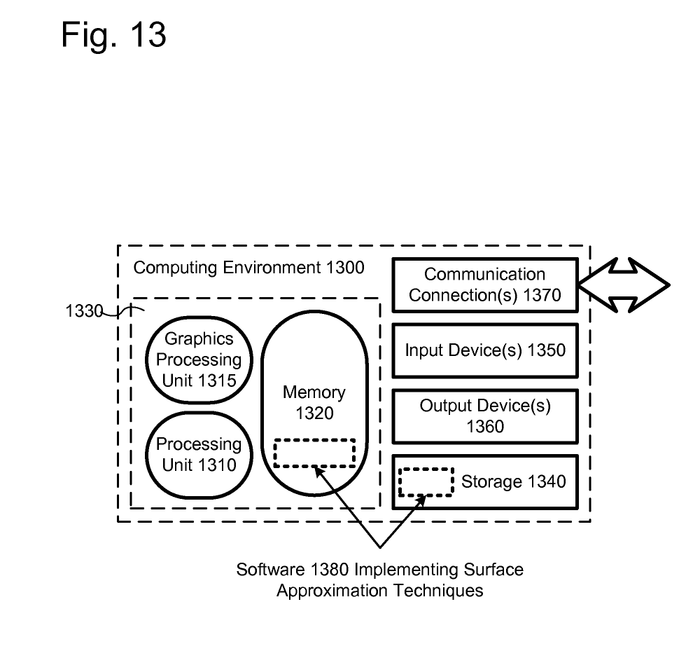

The above surface approximation techniques can be performed on any of a variety of computing devices. The techniques can be implemented in hardware circuitry, as well as in software executing within a computer or other computing environment, such as shown in FIG. 13.

FIG. 13 illustrates a generalized example of a suitable computing environment 1300 in which described embodiments may be implemented. The computing environment 1300 is not intended to suggest any limitation as to scope of use or functionality of the invention, as the present invention may be implemented in diverse general-purpose or special-purpose computing environments.

With reference to FIG. 13, the computing environment 1300 includes at least one processing unit 1310, a GPU 1315, and memory 1320. In FIG. 13, this most basic configuration 1330 is included within a dashed line. The processing unit 1310 executes computer-executable instructions and may be a real or a virtual processor. In a multi-processing system, multiple processing units execute computer-executable instructions to increase processing power. The memory 1320 may be volatile memory (e.g., registers, cache, RAM), non-volatile memory (e.g., ROM, EEPROM, flash memory, etc.), or some combination of the two. The memory 1320 stores software 1380 implementing the described techniques. The GPU 1315 may be integrated with the processing unit 1310 on a single board or may be contained separately.

A computing environment may have additional features. For example, the computing environment 1300 includes storage 1340, one or more input devices 1350, one or more output devices 1360, and one or more communication connections 1370. An interconnection mechanism (not shown) such as a bus, controller, or network interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and which can be accessed within the computing environment 1300. The storage 1340 stores instructions for the software 1380 implementing the described techniques.

The input device(s) 1350 may be a touch input device such as a keyboard, mouse, pen, or trackball, a voice input device, a scanning device, or another device that provides input to the computing environment 1300. For audio, the input device(s) 1350 may be a sound card or similar device that accepts audio input in analog or digital form, or a CD-ROM reader that provides audio samples to the computing environment. The output device(s) 1360 may be a display, printer, speaker, CD-writer, or another device that provides output from the computing environment 1300.

The communication connection(s) 1370 enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques described herein can be described in the general context of computer-readable media. Computer-readable media are any available media that can be accessed within a computing environment. By way of example, and not limitation, with the computing environment 1300, computer-readable media include memory 1320, storage 1340, communication media, and combinations of any of the above.

The techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “calculate,” “generate,” and “determine,” to describe computer operations in a computing environment. These terms are high-level abstractions for operations performed by a computer, and should not be confused with acts performed by a human being. The actual computer operations corresponding to these terms vary depending on implementation.

In view of the many possible variations of the subject matter described herein, we claim as our invention all such embodiments as may come within the scope of the following claims and equivalents thereto.

We claim:

1. A method of modeling a surface, the surface represented as a mesh of quadrilaterals, the method comprising, for each of one or more of the quadrilaterals, generating one or more control points for a Bézier patch which approximates a subdivision limit patch for the quadrilateral by applying one or more masks to the quadrilateral.

2. The method of claim 1, wherein the one or more control points approximate one or more Catmull-Clark limit points.

3. The method of claim 1, wherein one or more vertices of the quadrilateral is an extraordinary vertex.

4. The method of claim 3, wherein for each quadrilateral, one or more masks are applied to the quadrilateral which are each configured to apply a weight to one vertex of the quadrilateral that is equal to the valence of the vertex.

5. The method of claim 4, further comprising, for each of one or more edges of the one or more quadrilaterals, generating control points for the edge by computing midpoints of interior control points which are incident to the edge.

6. The method of claim 5, further comprising, for each of one or more vertices of the one or more quadrilaterals, generating control points for the vertex by computing a centroid of control points which surround the vertex.

7. The method of claim 1, further comprising for each of one or more of the quadrilaterals, generating one or more vectors for a tangent surface for the quadrilateral by applying one or more masks to the quadrilateral.

8. The method of claim 7, wherein each of the vectors represents a partial derivative with respect to a parameter used in a parameterization of the quadrilateral.

9. The method of claim 7, wherein masks used to generate vectors for tangent surfaces are created to provide continuous normal fields at boundaries between adjacent Bézier patches.

10. The method of claim 9, wherein applying masks to generate vectors for tangent surfaces comprises, for each of one or more quadrilaterals, applying masks to generate corner vectors for the quadrilateral.

11. The method of claim 10, wherein generating one or more vectors for a tangent surface further comprises:
calculating internal tangent vectors from generated Bézier control points; and
calculating boundary tangent vectors based at least in part on already-generated corner vectors.

12. The method of claim 7, further comprising displaying a representation of the surface based at least in part on the Bézier patches and tangent surfaces for the one or more quadrilaterals.

13. A computer-implemented system for displaying a surface, the system comprising:
a shape-approximation module configured to approximate shapes for one or more faces of a quadrilateral mesh approximating a Catmull-Clark subdivision surface, by applying one or more shape masks to each of the one or more faces;
a tangent-approximation module configured to approximate tangent vectors for one or more faces of the quadrilateral mesh by applying one or more tangent masks to each of the one or more faces; and
a display module, configured to render the approximated surface for a display at least in part based on the approximated shapes and the approximated normal vectors.

14. The system of claim 13, further comprising a subdivision module configured to utilize Catmull-Clark subdivision to create the quadrilateral mesh from a polygonal mesh.

15. The system of claim 13, wherein each of the one or more of the shape masks comprises one mask weight which is equal to the valence of the vertex to which the weight is applied.

16. The system of claim 13, wherein each of the one or more tangent masks comprises weights which are calculated so that normal vectors resulting from application of the one or more tangent patches will constitute a continuous normal field at edges between the one or more faces to which the one or more tangent masks are applied.

17. One or more computer-readable media containing instructions which, when executed by a computer cause the computer to perform a method for displaying a Catmull-Clark limit surface, the method comprising:
performing Catmull-Clark subdivision on a subdivision surface to create a quadrilateral mesh representing the surface;
for each face of the quadrilateral mesh, applying shape masks to the face in order to create a shape patch which approximates a Catmull-Clark limit surface for the face; and
displaying one or more of the approximated patches in order to display the surface.

18. The computer-readable media of claim 17, further comprising, for each face of the quadrilateral mesh, applying tangent masks to the face in order to create a tangent vector patch which approximates tangent vectors for the Catmull-Clark limit surface for the face.

19. The computer-readable media of claim 17, wherein, for each face of the quadrilateral mesh, applying shape masks to the face comprises shape masks which each comprise one weight which is based on the valence of the vertex to which the weight is applied.

20. The computer-readable media of claim 17, wherein, for each face of the quadrilateral mesh, applying tangent masks to the face comprises applying tangent masks which are constructed to maintain a continuous normal field at face edges.
